(19) United States
(12) Patent Application Publication
(10) Pub. No.: US 2024/0141126 A1
(43) Pub. Date: May 2, 2024

(54) METHOD FOR MAKING A LOW DENSITY THERMALLY RECYCLABLE POLYMER FOAM

(71) Applicant: Huntsman International LLC, The Woodlands, TX (US)

(72) Inventors: Hugo VERBEKE, Everberg (BE); Bram VANROY, Everbrg (BE); Erika VANEMPTEN, Everberg (BE); David BRIERS, Everberg (BE)

(21) Appl. No.: 18/282,337

(22) PCT Filed: Mar. 17, 2022
(86) PCT No.: PCT/EP2022/056927

§ 371 Date: Sep. 15, 2023

(30) Foreign Application Priority Data
Mar. 19, 2021 (EP) 21163686.5

(51) Int. Cl. C08J 9/10; B29C 35/02; B29C 44/02; B29C 44/08; B29C 44/34; B29K 75/00; B29K 105/04; C08G 18/10; C08G 18/48; C08G 18/76

(52) U.S. Cl. CPC C08J 9/103; B29C 35/0227; B29C 44/022; B29C 44/08; B29C 44/3403; B29C 44/355; C08G 18/10; C08G 18/4854; C08G 18/7671; B29K 2075/00; B29K 2105/04; B29K 2995/0063; C08G 2110/0058; C08G 2110/0066; C08J 2201/026; C08J 2203/04; C08J 2375/04

(57) ABSTRACT

A 2-step processing method to form a partly cross-linked polyurethane (PU) comprising foam having densities below 600 kg/m³, preferably in the range 20-300 kg/m³, said method comprising:
A first processing which comprises at least following steps:
a) providing a reactive mixture comprising an isocyanate composition comprising at least one isocyanate compound, an isocyanate-reactive composition comprising at least one isocyanate reactive compound, a crosslinking agent and a blowing agent composition comprising at least a heat activatable blowing agent which is heat activatable to achieve blowing at an activation temperature T_{activate}, and
b) allowing the reactive mixture to polymerize, optionally using a shape or mold, at a process temperature T_{process} wherein T_{process}<T_{activate} and T_{process}<Tₘₑₗₜ to form a polyurethane comprising material having a melting temperature Tₘₑₗₜ and which is solid at room temperature, and then
A second processing which comprises at least following steps:
c) placing the polyurethane comprising material in an autoclave, pressure vessel or pressurizable mold,
d) subjecting the polyurethane comprising material to a temperature sufficient to soften the polymer material (T_{softening}) wherein T_{softening}≥T_{activate} in combination with an elevated pressure P₁ wherein P₁ is higher than atmospheric pressure (Pₐₜₘ), and then subsequently
e) subjecting the polyurethane comprising material to a pressure reduction which is sufficient to achieve expansion (foaming) and to obtain the partly cross-linked polyurethane comprising foam

### FIELD OF INVENTION

The present invention relates to an improved and cost-efficient method for making a thermally recyclable polymer foam, more in particular a thermally recyclable polyurethane foam starting from a reactive mixture for making a polyurethane polymer.

The invention further relates to a 2-step processing method for the preparation of a thermally recyclable polymer foam whereby in the first processing a partly foamed or preferably non-foamed polymer is formed and in the second processing the polymer is expanded.

The invention further relates to the use of the thermally recyclable polymer foams obtained using the method of the invention in for example footwear applications.

### BACKGROUND OF THE INVENTION

The current state of the art foaming methods for making foamed polymers are limited to certain combinations of polymers and blowing agents whereby the melting temperature of the polymer used is below the blowing/activation temperature of the corresponding blowing agent. This restriction limits the number of combinations that effectively can be used and thereby limits the number of new foam materials that can be designed. Typically, low melting polymers are used as they can be processed (melted) below the blowing/activation temperature of many of the available blowing agents. If a polymer foam would be made using a polymer with a high melting temperature the number of blowing agents is often very limited as the lower temperature limit is set by the melting temperature of the polymer and the upper limit is set by the degradation temperature of the polymer using the process described in the current state of the art. Examples of polymers that have a high melting temperature are polyurethanes, polyureas, polyamides, polyaramides, polycaprolactam, poly(meth)acrylates.

Additionally, the current state of the art to make polymer foams often employs a crosslinking agent that can only be activated above the melting temperature of the polymer to allow the crosslinking agent to be embedded/mixed/compounded into the polymer matrix. This imposes similar limitations towards the selection and use of specific crosslinking agents as described above for the blowing agent. The fact that the activation/blowing temperature is above the melting temperature also imposes that the melt strength of the polymer very often should be sufficiently high in the specific case where maintaining a specific preform shape would be desired, thereby requiring a significant amount of crosslinking to do so and a very tight process control.

Several other foaming methods of the state of the art, use an autoclave wherein first a non-expanded (thermoplastic) polymer is introduced and put under high pressure using gaseous fluids in order to saturate the (thermoplastic) polymer which can contain a blowing agent. Followed by a depressurizing step to expand the (thermoplastic) polymer and obtain a foamed (thermoplastic) polymer. An example using this method can be found in WO 2015052265. WO 2015/052265 makes use of N₂ either by itself or in combination with CO₂ to expand the thermoplastic polymer. In order to reach very low-density polymers a very high pressure is required which comes at a large cost in the form of equipment and complexity of the process. This foaming method is therefore often split up in 2 different steps to decouple the high-pressure saturation step from the expansion step to optimize the use of the volume in the high-pressure vessel.

Above state of the art foaming processes for making foamed polymers either have lack of dimensional stability and cell quality and/or involve time and energy consuming processes (compounding steps above the melting temperature and/or very high pressures) to obtain low density polymers with excellent mechanical properties such as elongation, tensile strength and ball Rebound are required.

For environmental reasons, current polymer materials should be recyclable and/or easily transformable in polymer materials for another purposes. One of the preferred options is to create a polymer material which is thermally recyclable.

There is hence a need to develop an improved and cost-efficient process for making foamed polymer materials which are thermally recyclable.

### Aim of the Invention

It is a goal of the invention to develop an improved and cost-efficient process for making a thermally recyclable polymer foam.

More in particular the present invention relates to an improved and cost-efficient method for making a thermally recyclable polyurethane foam starting from a reactive mixture for making a polyurethane polymer.

It is a further goal to achieve low density polymer foams (for example having densities below 600 kg/m³ or even below 350 kg/m³ or even below 250 kg/m³) thereby using an improved and cost-efficient process.

It is a further goal to make it possible to achieve thermally recyclable polymer foams (such as polyurethane based foams) with excellent mechanical properties such as elongation (>200%), tensile strength and ball Rebound (≥40%).

The above goal is achieved by the 2-step processing method according to the invention whereby in a first processing a partly foamed or non-foamed intermediate polymer comprising a blowing agent is formed starting from a reactive mixture and in a second processing a foamed final polymer is obtained. The first processing may be performed fully independent from the second processing.

The goal is hence achieved by the 2-step processing method according to the invention wherein the cross-linking process is decoupled from the foaming process.

More in particular 2-step processing method according to the invention comprises:
A first processing wherein starting from a reactive mixture an intermediate polymer is formed which is “slightly crosslinked” and contains a non-activated blowing agent, and
A second processing wherein the blowing agent in the intermediate polymer is heat activated to obtain a foamed thermally recyclable polymer is foamed.

It is a further goal to develop thermally recyclable polymers, preferably having elastomeric properties for use in high energy return materials such as the use in highly demanding footwear applications, or low energy return vibration dampening and shock absorptive materials such as spring aids or railroad vibration isolation solutions, . . . .

### Definitions and Terms

In the context of the present invention the following terms have the following meaning:
1) The isocyanate index or NCO index or index is the ratio of NCO-groups over isocyanate-reactive hydrogen atoms present in a formulation, given as a percentage:

$$\frac{[ NCO ] \times 100}{[ active hydrogen ]} ( \% )$$

In other words, the NCO-index expresses the percentage of isocyanate actually used in a formulation with respect to the amount of isocyanate theoretically required for reacting with the amount of isocyanate-reactive hydrogen used in a formulation.
It should be observed that the isocyanate index as used herein is not only considered from the point of view of the actual polymerisation process preparing the material involving the isocyanate ingredients and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are also taken into account in the calculation of the isocyanate index.
2) The term “intermediate” or “intermediate polymer” as used herein, refers to a non-foamed or partly foamed piece of polymer material which comprises a non-activated blowing agent, and which is slightly cross-linked.
3) The term “polyurethane”, as used herein, is not limited to those polymers which include only urethane or polyurethane linkages. It is well understood by those of ordinary skill in the art of preparing polyurethanes that the polyurethane polymers may also include allophanate, carbodiimide, uretidinedione, and other linkages in addition to urethane linkages.
4) The term “polyurethane comprising polymer”, as used herein, is referring to a polymer material which comprises at least 50 wt % of polyurethane polymers, preferably at least 70 wt % of polyurethane polymers, more preferably at least 80 wt % of polyurethane polymers and most preferably at least 90 wt % of polyurethane polymers based on the total weight of the polymer material (foamed or non-foamed) and polyurethane polymers are limited to those polymers which include mainly urethane or polyurethane linkages (including some allophanate, carbodiimide, uretonimine, uretidinedione, and other linkages in addition to urethane linkages).
5) The term “thermally recyclable” is used herein to designate a polymer material that is reprocessable at an elevated temperature above the melting temperature of the polymer.
6) The term “thermoplastic” is used herein in its broad sense to designate a material that is reprocessable at an elevated temperature above the melting temperature of the polymer, whereas “thermoset” designates a polymer material that exhibits high temperature stability without such reprocessability at elevated temperatures. A thermoplastic material will lose its structural integrity upon heating above its melting temperature and will start to flow.
7) The term “cross-linked” polymer refers to a polymer wherein the polymer chains are joined together by a series of chemical (covalent) bonds wherein these bonds are called “cross-links”. A non-cross-linked polymer or linear polymer refers to a polymer wherein the monomer units of a polymer chain have end-to-end links and the individual polymer chains are not linked to each other.
8) The term “slightly cross-linked”, “partly cross-linked” and “partly cross-linked polyurethane comprising polymer”, as used herein, is referring to a polymer material which contains at least some cross-links where a chemical bond is formed between two adjacent polymer chains. A partly cross-linked polymer hence contains linear polymer chains and cross-linked polymer chains.

A partly cross-linked polymer as referred to in this invention can be made by using a crosslinker or crosslinking agent in the reactive mixture used to make the polymer.
9) The term “elastomeric material” or “elastomer” as determined according to ASTM D1566 designates a material which, at room temperature, is capable of recovering substantially in shape and size after removal of a deforming force.
10) The term “average nominal functionality of a composition” (or in short “functionality of a composition”) is used herein to indicate the number average of functional groups per molecule in a composition. It reflects the real and practically/analytically determinable number average functionality of a composition. In case of a blend of materials (isocyanate blend, polyol blend, reactive mixture) the “average nominal functionality” of the blend is identical to the “molecular number average functionality” calculated via the total number of molecules of the blend in the denominator. It thereby requires using the real and practically/analytically determinable number average functionality of each of the chemical compounds of the blend. In case of a reactive mixture the molecular number average functionality of the complete reactive mixture should be taken into account (thus including all functional groups originating from isocyanate and isocyanate reactive compounds).
11) The term “hydroxyl functionality” of a composition refers to the number average of hydroxyl functional groups in that composition (average nominal hydroxyl functionality). The term “isocyanate functionality” of a composition refers to the number average of isocyanate functional groups in that composition (average nominal isocyanate functionality). The term “iso-reactive functionality” of a composition refers to the number average of isocyanate reactive hydrogen containing functional groups in that composition typically originating from amines and polyols (average nominal iso-reactive functionality).
12) The term “difunctional” as used herein means that the average nominal functionality is about 2. A difunctional polyol (also referred to as a diol) refers to a polyol having an average nominal hydroxyl functionality of about 2 (including values in the range 1.95 up to 2.05). A difunctional isocyanate refers to an isocyanate composition having an average nominal isocyanate functionality of about 2 (including values in the range 1.95 up to 2.05).
13) The expression “Reaction system”, “Reactive foam formulation” and “Reactive mixture” as used herein refers to a combination of reactive compounds used to make a polymer. In case of a polyurethane comprising polymer the polyisocyanate compounds are usually kept in one or more containers separate from the isocyanate-reactive compounds before bringing these compounds together to form a reactive mixture.
14) The term “room temperature” refers to temperatures of about 20° C., this means referring to temperatures in the range 18° C. to 25° C. Such temperatures will include, 18° C., 19° C., 200 C, 21° C., 22° C., 23° C., 24° C. and 25° C.
15) Unless otherwise expressed, the “weight percentage” (indicated as % wt or wt %) of a component in a composition refers to the weight of the component over the total weight of the composition in which it is present and is expressed as percentage.
16) Unless otherwise expressed, “parts by weight” (pbw) of a component in a composition refers to the weight of the component over the total weight of the composition in which it is present and is expressed as pbw.
17) The “density” of a foam is referring to the apparent density as measured on foam samples including their skin by determining the weight and volume of the sample according to ISO 1183-1 and determining the density as the weight to volume ratio expressed in kg/m³. Alternatively, when a sample without skin needs to be measured, the density can be measured by cutting a parallelepiped of foam, weighing it and measuring its dimensions. The apparent density is the weight to volume ratio as measured according to ISO 845 and is expressed in kg/m³.
18) Unless otherwise specified, “CLD hardness” and “CLD 40” refer to Compression Load Deflection at 40% compression measured according to ISO 3386/1.
19) “Resilience” and “Rebound” (also referred to as ball rebound) is measured according to ISO 8307 and is expressed in % with the provisio that the resilience is measured on non-crushed samples.
20) “Tear strength” and “Angle tear strength” as referred to herein is measured according to ISO 34-1 (without using a cut) and is expressed in N/m. Tear strength in general and more in particular angle tear strength measures the ability of a foam to resist tearing or shredding. This is important in applications where foams must be handled frequently, such as in upholstering.
21) “Tensile strength” and “elongation” as referred to herein is measured according to DIN 53504 and is expressed in MPa. The test is performed using a S2 specimen type and a test speed of 100 mm/min.
22) A “physical blowing agent” herein refers to permanent gasses such as CO₂, N₂ and air as well as volatile compounds that expand the polymer by vaporization. The physical blowing agents also include those compounds which are in some cases incapsulated. The bubble/foam-making process is irreversible and endothermic, i.e. it needs heat to volatilize the (liquid) blowing agent.
23) A “chemical blowing agent” includes compounds that are activated and/or decompose under processing conditions and expand the polymer by the gas produced as a side product.
24) The “Process Temperature” or “T_{process}” or “T_{polymerization}” as used herein refers to the maximum reaction temperature achieved during the process for making the polymer material, more in particular the maximum reaction temperature achieved during the process for making the polyurethane polymer thereby starting from the reactive (liquid) mixture. As used herein T_{process} refers to the maximum temperature achieved during the first processing (polymerization) in the 2-step processing method process according to the invention.
25) “Reaction exotherm” refers herein to the temperature generated during the polymer formation (more in particular the maximum temperature achieved EUR 51142/WO during the first processing of the 2-step processing method according to the invention.
26) The term “Activation Temperature” or “T_{activate}” as used herein refers to the temperature or temperature range required to achieve activation of the heat activatable blowing agent according to the invention.
27) The term “Melting Temperature” or “Tₘₑₗₜ” as used herein refers to the temperature or temperature range at which a polymer material changes state from solid to liquid. At the “Melting Point” the solid and liquid phase exist in equilibrium. The melting temperature is determined on an expanded sample as the peak melting temperature of the endothermic peak in the DSC curve measured according to ISO 11357-3-2011 using a heating rate of 10 K/min and is expressed in ° C. In case there is doubt, the end-set temperature (peak end temperature) is used. To avoid damage to the equipment (from the foaming process) the DSC measurement is performed on a sample which was already expanded by exposure to a temperature higher than the melting temperature but below the degradation temperature.
28) The term “Softening Temperature” or “T_{softening}” as used herein refers to a temperature or temperature range at which a polymer material softens and start to experience noticeable changes in physical properties but wherein the polymer is still in its solid state (T_{softening}<Tₘₑₗₜ). At or above the softening temperature the polymer material can be elongated by expansion force produced by the blowing agent to an extent a foamed polymer material can be obtained.

### DETAILED DESCRIPTION

According to a first aspect of the invention, a process is disclosed for the preparation of a partly cross-linked polyurethane comprising polymer foam having densities in the range 20 up to 800 kg/m³, preferably below 600 kg/m³, more preferably below 350 kg/m³, most preferably below 250 kg/m³.

The process according to invention comprises a 2-step processing method wherein the first processing involves the polymerization process to form a non-foamed or partly foamed polyurethane comprising polymeric material starting from a liquid reactive mixture and the second processing involves the foaming process to form a foamed polyurethane comprising polymeric material starting from the solid polymeric material.

The 2-step processing method according to the invention to form a partly cross-linked polyurethane (PU) comprising foam having densities below 600 kg/m³, preferably in the range 100-300 kg/m³ comprises:
A first processing which comprises at least following steps:
a) providing a reactive mixture comprising an isocyanate composition comprising at least one isocyanate compound, an isocyanate-reactive composition comprising at least one isocyanate reactive compound, a crosslinking agent and a blowing agent composition comprising at least a heat activatable blowing agent which are heat activatable to achieve blowing at a activation temperature T_{activate}, and
b) allowing the reactive mixture to polymerize, optionally using a shape or mold, at a process temperature T_{process} wherein T_{process}<T_{activate} and T_{process}<Tₘₑₗₜ to form a polyurethane comprising material having a melting temperature Tₘₑₗₜ and which is solid at room temperature, and then
A second processing which comprises at least following steps:
c) placing the polyurethane comprising material in an autoclave, pressure vessel or pressurizable mold,
d) subjecting the polyurethane comprising material to a temperature sufficient to soften the polymer material (T_{softening}) wherein T_{softening}>T_{activate} in combination with an elevated pressure P₁ wherein P₁ is higher than atmospheric pressure (Pₐₜₘ), and then subsequently
e) subjecting the polyurethane comprising material to a pressure reduction which is sufficient to achieve expansion (foaming) and to obtain the partly cross-linked polyurethane comprising foam

According to embodiments, the advantage of the 2-step processing method according to the invention is that it decouples the cross-linking (polymerization) step from the step where the blowing agent is heat activated. This allows more flexibility to select the ingredients of the reactive mixture and additionally it gives better process control compared to processes wherein the crosslinking agent which provides crosslinking is active at the same time when the blowing agent is activated. An additional advantage is the reduction of the overall energy used in the process to make the expanded foam.

The 2-step processing method according to the invention may be used for the preparation of any foamed polyurethane comprising material which are capable of being processed (polymerized) below the activation temperature of the corresponding (chemical) heat activatable blowing agent used.

It is an advantage of the 2-step processing method according to the invention that preforms of at least partly cross-linked polyurethane comprising materials can be formed which can be (further) foamed at any time. The cross-linking agent in the reactive mixture is chosen such that a cross-linking action is achieved sufficient to maintain shape prior to foaming and during activation of the chemical blowing agent such that controlled expansion is possible.

A further advantage of the 2-step processing method according to the invention is the fact that very low-density polyurethane comprising foams can be achieved even by using moderate pressures during the blowing (foaming) process. As a result, the 2-step processing method according to the invention is more cost and energy effective and straightforward.

According to embodiments the at least partly cross-linked polyurethane comprising foam is a thermally recyclable polyurethane comprising foam.

According to embodiments, the reactive mixture used to make the partly cross-linked polyurethane comprising foam, more in particular the thermally recyclable polyurethane comprising foam according to the invention has an overall a nominal average functionality in the range 2-2.3. More preferably the nominal average functionality is in the range 2-2.2; in the range 2.002-2.2; in the range 2.005-2.2 or in the range 2.01-2.2. Most preferably the nominal average functionality of the reactive mixture is in the range 2.01-2.1.

According to embodiments, the reactive mixture used to make the partly cross-linked polyurethane comprising foam, more in particular the thermally recyclable polyurethane comprising foam according to the invention has a nominal average iso-reactive (hydroxyl/amine, . . . ) functionality in the range 1.5-4; More preferably in the range 1.5-3; in the range 1.5-2.5 or in the range 2-2.5. Most preferably the nominal average iso-reactive (hydroxyl/amine, . . . ) functionality in the range 2-2.2.

According to embodiments, the reactive mixture used to make the partly cross-linked polyurethane comprising foam, more in particular the thermally recyclable polyurethane comprising foam according to the invention has a nominal average iso-reactive (hydroxyl/amine, . . . ) and isocyanate functionality in the range 1.5-4; more preferably in the range 1.5-3; in the range 1.5-2.5 or in the range 2-2.5. Most preferably the nominal average iso-reactive (hydroxyl/amine, . . . ) and isocyanate functionality is in the range 2-2.2.

According to embodiments, the reactive mixture used to make the partly cross-linked polyurethane comprising foam, more in particular the thermally recyclable polyurethane comprising foam according to the invention has a nominal average isocyanate functionality in the range 1.8-3; preferably in the range 2-2.5; more preferably in the range 2-2.2.

According to embodiments, the crosslinking agent in the reactive mixture is selected from isocyanate reactive compounds having an (nominal average) iso-reactive (hydroxyl/amine, . . . ) functionality higher than 2. The crosslinking agent is selected in amount and nature to give sufficient cohesion to provide melt stability during blowing agent activation and foaming. Suitable crosslinking agents contain more than 2 iso reactive (hydroxyl, amine, thiol, carboxyl, epoxy, . . . ) functional groups or combinations thereof. There are no specific limitations to the molecular weight (MW) of the crosslinking agent (thus including both very low and high MW species). Examples of suitable low MW crosslinkers are triethanolamine, diethanolamine, glycerol, trimethylolpropane, pentaerythritol, Jeffamine® T403, . . . . Examples of suitable high MW crosslinkers are EO/PO polyols or amines prepared from an initiator molecule with a functionality >2 such as Daltocel® F435 or Jeffamine® T5000. Another group of suitable high MW crosslinkers are castor oil based iso-reactive compounds or derivatives therefrom.

According to embodiments, the crosslinking agent in the reactive mixture is selected from isocyanate reactive compounds having at least 1 iso-reactive (hydroxyl/amine, . . . ) or isocyanate functionality in combination with at least 1 non-iso reactive functionality (acrylates, methacrylates, . . . ). Examples of these compounds are hydroxy(meth)acrylates or isocyanate(meth)acrylates such as hydroxyethylmethacrylate or Isocyanatoethyl methacrylate.

According to embodiments, the crosslinking agent in the reactive mixture is selected from compounds and/or catalysts that introduce a crosslinking reaction. The crosslinking agent is selected in amount and nature to give sufficient cohesion to provide melt stability during blowing agent decomposition and foaming. Typical crosslinking agents include isocyanate catalysts that induce crosslinking such as trimerization, allophanate or biuret catalysts. Examples of these catalysts are organic salts from alkoxides wherein said organic salt is selected from alkali metal, earth alkali metal, a transition metal such as Ti and/or quaternary ammonium organic salts. Other examples are copper acetate monohydrate, metal acetylacetonate, thionyl chloride and multicomponent bismuth molybdate. Alternatively crosslinking agents include peroxides, or similar chemicals, that decompose at certain temperatures and thereby can result in crosslinks, such as Bis(tert-butyldioxyisopropyl)benzene.

According to embodiments, the crosslinking agent in the reactive mixture is selected from compounds which are reactive at temperatures below the or equal to the processing temperature achieved in the first processing (T_{process}).

According to embodiments, the crosslinking agent in the reactive mixture is selected from compounds which are reactive at temperatures below the or equal to the softening temperature achieved in the second processing (T_{softening}).

According to embodiments, the reactive mixture includes chain extenders which have low molecular weight difunctional amines and/or polyols. Preferably the chain extenders are diols, diamines or amino alcohols having a molecular weight of 62-600 g/mol. Nonlimiting examples of suitable diols that may be used as extenders include ethylene glycol and lower oligomers of ethylene glycol including diethylene glycol, triethylene glycol and tetraethylene glycol; propylene glycol and lower oligomers of propylene glycol including dipropylene glycol, tripropylene glycol and tetrapropylene glycol; cyclohexanedimethanol, 1,6-hexanediol, 2-ethyl-1,6-hexanediol, 1,4-butanediol, 2,3-butanediol, 1,5-pentanediol, 1,3-propanediol, butylene glycol, neopentyl glycol, dihydroxyalkylated aromatic compounds such as the bis (2-hydroxyethyl) ethers of hydroquinone and resorcinol; p-xylene-α,α′-diol; the bis (2-hydroxyethyl) ether of p-xylene-α,α′-diol; m-xylene-α,α′-diol and combinations of these. Suitable diamine extenders include, without limitation, ethylene diamine, Propane-1,3-diamine, 1,4-Diaminobutane, and combinations of these. Other typical chain extenders are amino alcohols such as ethanolamine, propanolamine, butanolamine, and combinations of these.

According to embodiments, the crosslinking agent in the reactive mixture is selected from isocyanate compounds with a functionality >2 such as polymeric MDI or modified MDI compounds such as uretonimine, biurets, allophanates, isocyanate trimers (polyisocyanurates), . . . . Commercial examples of isocyanate compounds with a functionality >2 are Suprasec® 5025, Suprasec® 2020 and Suprasec® 2185 from Huntsman.

According to embodiments, other conventional ingredients (additives and/or auxiliaries) may added to the reactive mixture according to the invention. These include catalysts, surfactants, flame proofing agents, plasticizers, diluents, microspheres, antioxidants, antistatic agents, fillers, pigments, stabilizers and the like.

According to embodiments, suitable catalysts accelerate in particular the reaction between the NCO groups of the diisocyanates a) and accelerate the iso-reactive groups of the isoreactive compounds and are selected from those known in the prior art such as metal salt catalysts, such as organotins, and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl) hexahydrotriazine, 2,4,6-tris(dimethylaminomethyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene triamine, triethanolamine, dimethylethanolamine, bis(dimethylaminoethyl)ether, tris(3-dimethylamino)propylamine, or its acid blocked derivatives, and the like, as well as any mixture thereof. Catalysts also include all sorts of in-situ formed catalysts, an example is the combination of a lithium halide compound with an epoxide to form a polyurethane catalyst. It is possible to use a combination of both standard and in-situ formed catalysts. The catalyst compound should be present in the reactive mixture in a catalytically effective amount, generally from about 0 to 5 wt %, preferably 0 to 2 wt %, most preferably 0 to 1 wt % based on total weight of all reactive ingredients used.

According to embodiments, the step of forming the reactive mixture (mixing the ingredients) and allowing the reactive mixture to polymerize during the first processing is performed at a temperature which is sufficient to activate crosslinking but insufficient to activate the blowing agent to initiate blowing (foaming).

According to embodiments, the ingredients used to form the reactive mixture according to the invention are combined at an isocyanate index between 80 and 120, more preferably at an isocyanate index from 90 up to 110, more preferably at an isocyanate index from 90 up to 105, more preferably at an isocyanate index from 98 up to 102. Most preferably at an isocyanate index from 99-101.

According to embodiments, any known blowing agent may be employed which is compatible with the process according to the invention, that releases sufficient gas to achieve a density reduction during foaming. Suitable blowing agents may be selected from the group of chemical and/or physical blowing agents or any combinations thereof.

Examples of suitable chemical blowing agents include both endothermic and exothermic blowing agents or combinations thereof. The examples include gas (e.g. N₂, CO₂, . . . ) forming compounds such as carbonates, bicarbonates, azo compounds (e.g. Azodicarbonamides, Azobisisobutyronitrile, azodicarbonic methyl ester, diazabicyclooctane, . . . ), Nitroso compounds (e.g. dinitrosopentamethylenetetramine), citrates, nitrates, borohydrides, carbides such as alkaline earth and alkali metal carbonates and bicarbonates (e.g. sodium bicarbonate and sodium carbonate, ammonium carbonate), diaminodiphenylsulphone, anhydrides, carbazides, hydrazides (e.g. toluenesulfonyl hydrazide, benzene sulfonyl hydrazide, trihydrazinotriazine), malonic acids, citric acids, sodium monocitrates, ureas, and acid/carbonate mixtures. Commercial examples can be found under different trade names and include different grades of Tracell®, Unifoam®, Unifoam® AZ, Celogen®, Cell paste, Porofor®, Hydrocerol®, Unicell®, Neocellborn®, Binyfor®, Azocel®, Activex®, Cellcom®, Luperfoam®, Expandex®, Kempore®.

It is known to those skilled in the art that certain modifications to the chemistry of chemical blowing agents can change the blowing/activation temperature and these compounds. In the case of Azodicarbonamide the chemicals used to modify the blowing/activation temperature can be metal compounds (ZnO, zinc stearate, Ba—Zn and K—Zn systems, and lead salts), inorganic or organic substances (bases, acids, urea). All these modifications to influence the blowing/activation temperature are included in the scope of the invention in order to prepare a suitable blowing agent package.

Examples of suitable physical blowing agents include both encapsulated and non-encapsulated blowing agents. Examples of suitable non-incapsulated blowing agents are chlorofluorocarbons, partially halogenated hydrocarbons or non-halogenated hydrocarbons (e.g. propane, n-butane, isobutane, n-pentane, isopentane and/or neopentane). Examples of suitable encapsulated physical blowing agents include expandable microspheres where a gas or gas forming compound is encapsulated in a polymer shell (e.g. polymer microsphere). Commercial examples can be found under different trade names and include Expancel®, Cellcom®, Advancell®, Tracel®, Kureha® . . . .

According to embodiments, the heat activatable blowing agent used in the first processing is preferably selected from a blowing agent having an activation temperature above 80 C, more preferably at least 100° C., more preferably at least 130° C., most preferably at least 140° C.

According to embodiments, the heat activatable blowing agent used in the first processing is preferably selected from a chemical blowing agent selected from Azodicarbonamide, Azobisisobutyronitrile and/or Dinitrosopentamethylenetatramine.

According to embodiments, the blowing agent composition comprises at least 50 wt %, preferably >75 wt %, more preferably >90 wt %, most preferably >98 wt % of heat activatable chemical blowing agents which are heat activatable at an activation temperature T_{activate}, which is higher than the processing (polymerization) temperature T_{process} (T_{process}<T_{activate}) based on the total weight of the blowing agent composition.

According to preferred embodiments, the blowing agent composition comprises a heat activatable chemical blowing agent selected from Azodicarbonamide, Azobisisobutyronitrile and/or Dinitrosopentamethylenetatramine in combination with heat activatable encapsulated physical blowing agents selected from thermoplastic microspheres encapsulating a gas such as Expancel®. The thermoplastic microspheres preferably have an encapsulation (shell) which softens at a temperature which is higher than the processing (polymerization) temperature T_{process} such that encapsulated gas can expand during the second processing. In some cases the shell can soften upon heating until it bursts where the polymer matrix keeps the gas trapped.

According to embodiments, the blowing agent composition comprises only heat activatable chemical blowing agents which are heat activatable at an activation temperature T_{activate}, which is higher than the processing (polymerization) temperature T_{process} (T_{process}<T_{activate}).

According to embodiments, the reactive mixture comprises less than 0.5 wt % water, preferably less than 0.25 wt % water, more preferably less than 0.1 wt % water and most preferably less than 0.05 wt % water calculated on the total weight of the reactive mixture.

According to embodiments, the amount of water (if present) in the reactive mixture is in the range 0 up to 0.5 wt % water, preferably in the range 0 up to 0.25 wt % water, more preferably in the range 0 up to 0.1 wt % water, most preferably in the range 0 up to 0.05 wt % water calculated on the total weight of the reactive mixture.

According to embodiments, the amount of blowing agents used in the reactive mixture can vary based on, for example, the intended use and application of the foam polymer material and the desired foam stiffness and density.

According to embodiments, the amount of blowing agents used in the reactive mixture is in the range 0.1 to 20 parts by weight (pbw), more preferably from 0.5 to 20 pbw, more preferably from 1 to 10 pbw per hundred weight parts of the reactive mixture.

According to embodiments, the polyurethane comprising material obtained after the first processing may be a shaped and sized preform. Said preform is a solid material which is not yet foamed or only partly foamed. The density of said preform is preferably in the range 500-1400 kg/m³.

According to embodiments, the intermediate polyurethane comprising material obtained after the first processing may be a shaped and sized preform comprising fillers. Said preform is a solid material which is not yet foamed or only partly foamed. The density of said preform is preferably in the range 1200-5000 kg/m³.

According to embodiments, the polyurethane comprising material obtained after the first processing may be a shaped and sized preform. This shaped and sized preform can then be reshaped (such as by dye cutting) to obtain a new shaped and sized preform that can be used in the second processing.

According to embodiments, the first processing is performed in a first mold to achieve a preform and/or is reshaped in such way that a smaller version of the end-product is obtained and the second processing is performed in a second (larger) mold to achieve the final polymer foam shape. Alternatively the second processing does not require a second mold.

According to embodiments, the first processing is performed in a first mold to achieve a preform and the second processing is performed in a second (larger) mold to achieve the final polymer foam shape.

According to embodiments, the scrap/waste of shaping/reshaping the polyurethane comprising material obtained after the first processing, may be (re-)used by incorporation in a new first processing step of a different or identical polymer material. This method, for example, allows the efficient re-use of production waste materials.

According to some embodiments, the polyurethane comprising material obtained after the first processing may be a shaped and sized preform which is solid at room temperature and has only a limited degree of foaming due to the presence of water in the reactive mixture and/or the (limited) addition of blowing agents which are already activatable at a temperature below T_{process}.

According to embodiments, the polyurethane comprising material obtained after the first processing may be a shaped and sized preform and the first processing is performed in a first mold. This first mold is different to the second mold which may be used in the second processing and which corresponds to the final desired shape of the polyurethane comprising foam according to the invention.

According to embodiments, the polyurethane comprising foam material obtained after the second processing may be a reshaped and/or reformed. Suitable methods are for example dye cutting or thermoforming.

According to embodiments, the second processing which comprises placing the polyurethane comprising material in a pressure vessel or pressurized mold (step b)) is performed in an autoclave in an inert atmosphere. The inert atmosphere may be selected from gasses such as for example nitrogen, argon, carbondioxide and mixtures of these gasses.

According to embodiments, the second processing which comprises placing the polyurethane comprising material in a pressure vessel or pressurized mold (step b)) is performed in an autoclave in a non-inert atmosphere. The non-inert atmosphere may be selected from gasses such as for example (dry) air.

According to embodiments, the step of subjecting the polymer material to a temperature sufficient to soften the polymer material (T_{softening}) wherein T_{softening}>T_{activate} in combination with a pressure P₁ larger than atmospheric pressure (Pₐₜₘ) is maintained for a period of time sufficient to (at least partially) activate the (chemical) heat activatable blowing agent and saturate the polymer. Selecting the optimal time for step (d) will result in evenly distributed cells and homogeneous cell size.

According to embodiments, the heating of the polymer material may be achieved by convective heating by heat of the gases present in the pressure vessel.

According to embodiments, the step of subjecting the polyurethane comprising material to an elevated pressure P₁ (step d)) wherein P₁ is higher than atmospheric pressure (Pₐₜₘ) is performed in a pressure range Pₐₜₘ<P₁<250 bar. Preferably the pressure in step d is in a pressure range Pₐₜₘ<P₁<100 bar, more preferably is in the range 5-100 bar, more preferably is in the range 10-100 bar, most preferably in the range 10-50 bar.

According to embodiments, the step of subjecting the polyurethane comprising material to an elevated pressure P₁ (step d)) wherein P₁ is higher than atmospheric pressure (Pₐₜₘ) is performed in a pressure range Pₐₜₘ<P₁<250 bar. Preferably the pressure in step d is in a pressure range Pₐₜₘ<P₁<250 bar, more preferably is in the range 5-250 bar, more preferably is in the range 10-250 bar, most preferably in the range 25-250 bar.

According to embodiments, the step of increasing the pressure in the pressure vessel (step d) is performed at a temperature below the melting temperature of the polyurethane comprising material. In case the polyurethane comprising material is thermoplastic polyurethane, the temperature within the pressure vessel is preferably kept in the range 30-250° C., preferably in the range 50-250° C., more preferably in the range 100-250° C., most preferably in the range 130-250° C.

According to embodiments, the step of reducing the pressure (step e)) during the second processing is a rapid pressure reduction which is sufficient to allow full expansion by the blowing gases released in step d) and is preferably performed at a rate of several bar/minute, more preferably at a rate of several bar/second, more preferably >10 bar/second, more preferably >50 bar/second.

According to embodiments, the step of reducing the pressure (step e)) during the second processing is performed using a pressure drop until atmospheric pressure (Pₐₜₘ) is achieved. Step d) is preferably performed at a temperature equal or above the softening point of the polymer material and optionally above the melting temperature of the polymer material (Tₘₑₗₜ). It is also possible according to embodiments to first lower the temperature of the pressure vessel or mould before reducing the pressure to obtain a foamed polymer.

According to preferred embodiments, the polyurethane comprising polymer material is a thermoplastic polyurethane (TPU) polymer material. TPU and processes for their production are well known. By way of example, TPUs can be produced via reaction of (a) one or more polyfunctional isocyanates with (b) one or more isocyanate reactive compounds having a molecular weight in the range of from 500 g/mol to 500000 g/mol and, if appropriate, (c) chain extenders having a molecular weight in the range of from 50 g/mol to 499 g/mol, and if appropriate in the presence of (d) catalysts and/or of (e) conventional auxiliaries and/or conventional additives.

The one or more polyfunctional isocyanates used for forming the partly crosslinked polyurethane comprising foam (more in particular TPU) used in the process according to the invention may be well-known aliphatic, cycloaliphatic, araliphatic, and/or aromatic isocyanates, preferably diisocyanates. For example tri-, tetra-, penta-, hexa-, hepta- and/or octamethylene diisocyanate, 2-methylpentamethylene 1,5-diisocyanate, 2-ethylbutylene 1,4-diisocyanate, 1,5-pentamethylene diisocyanate, 1,4-butylene diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′- and 2,2′-diisocyanate, 2,2′-, 2,4′- and/or 4,4′-diphenylmethane diisocyanate (MDI), naphthylene 1,5-diisocyanate (NDI), 2,4- and/or 2,6-tolylene diisocyanate (TDI), diphenylmethane diisocyanate, 3,3′-dimethylbiphenyl diisocyanate, 1,2-diphenylethane diisocyanate, and/or phenylene diisocyanate.

The one or more polyfunctional isocyanates used forming the partly crosslinked polyurethane comprising foam (more in particular TPU) used in the process according to the invention mainly comprises pure 4,4′-diphenylmethane diisocyanate or mixtures of that diisocyanate with one or more other organic polyisocyanates, especially other diphenylmethane diisocyanates, for example the 2,4′-isomer optionally in conjunction with the 2,2′-isomer. The polyisocyanate component may also be an MDI variant derived from a polyisocyanate composition containing at least 95% by weight of 4,4′-diphenylmethane diisocyanate. MDI variants are well known in the art and, for use in accordance with the invention, particularly include liquid products obtained by introducing carbodiimide groups into said polyisocyanate composition and/or by reacting with one or more polyols.

Preferred polyfunctional isocyanates are those containing at least 80% by weight of 4,4′-diphenylmethane diisocyanate. More preferably, the 4,4′-diphenylmethane diisocyanate content is at least 90, and most preferably at least 95% by weight, the remaining part (optionally) being higher functionality isocyanates such as polymeric MDI, uretonimines, biuret, allophanates . . . .

The one or more compounds reactive toward isocyanates (isocyanate reactive compounds) used for forming the partly crosslinked polyurethane comprising foam (more in particular TPU) used in the process according to the invention may have a molecular weight of between 500 g/mol and 500000 g/mol and may be selected from polyesteramides, polythioethers, polycarbonates, polyacetals, polyolefins, polybutadienes, polysiloxanes and, especially, polyesters and polyethers or mixtures thereof.

The one or more compounds reactive toward isocyanates used for forming the partly crosslinked polyurethane comprising foam (more in particular TPU) suitable in the process according to the invention are preferably diols, such as polyether diols and may include products obtained by the polymerization of a cyclic oxide, for example ethylene oxide, propylene oxide, butylene oxide or tetrahydrofuran in the presence, where necessary, of difunctional initiators. Suitable initiator compounds contain at least 2 active hydrogen atoms and include water, butanediol, ethylene glycol, propylene glycol, diethylene glycol, triethylene glycol, dipropylene glycol, 1,3-propane diol, neopentyl glycol, 1,4-butanediol, 1, 5-pentanediol, 2-methyl-1,3-propanediol, 1,6-pentanediol and the like. Mixtures of initiators and/or cyclic oxides may be used.

The one or more compounds reactive toward isocyanates used for forming the partly crosslinked polyurethane comprising foam (more in particular TPU) used in the process according to the invention are preferably diols, such as polyester and may include hydroxyl-terminated reaction products of dihydric alcohols such as ethylene glycol, propylene glycol, diethylene glycol, 1,4-butanediol, neopentyl glycol, 2-methyl-1,3-propanediol, 1,6-hexanediol or cyclohexane dimethanol or mixtures of such dihydric alcohols, and dicarboxylic acids or their esterforming derivatives, for example succinic, glutaric and adipic acids or their dimethyl esters, sebacic acid, phthalic anhydride, tetrachlorophthalic anhydride or dimethyl terephthalate or mixtures thereof. Polycapro lactones and unsaturated polyesterpolyols should also be considered.

According to embodiments, the partly crosslinked polyurethane comprising foam is an elastomeric foam.

According to embodiments, the partly crosslinked polyurethane comprising foam is a foam with mainly (>50%) closed cells.

According to embodiments, the partly crosslinked polyurethane comprising foam is a thermoplastic foam wherein the degree of cross-linking is defined by the functionality of the reactive mixture.

According to embodiments, the partly crosslinked polyurethane comprising foam has a density below 800 kg/m³, preferably below 600 kg/m³, more preferably <350 kg/m³. Preferred foams have densities in the range 20-300 kg/m³, in the range 100-300 kg/m³, in the range 100-200 kg/m³ or alternatively in the range 200-300 kg/m³.

According to embodiments, the partly crosslinked polyurethane comprising foam has a shore A hardness in the range 5 to 95 Sh A.

According to embodiments, the partly crosslinked polyurethane comprising foam has a rebound in the range 20-90%.

According to embodiments, the partly crosslinked polyurethane comprising material obtained in the first processing may be submitted to a post-curing step before the second processing, preferably said post-curing is performed at a temperature equal to or above the processing temperature T_{process}, more preferably at a temperature equal to or above the activation temperature T_{activate} and wherein said post-curing is preferably performed at a temperature equal to or below the melting temperature Tₘₑₗₜ, more preferably at a temperature equal to or below the softening temperature T_{softening}, most preferably the post-curing is performed at a temperature between the activation temperature T_{activate} and the softening temperature T_{softening}.

According to embodiments, the partly crosslinked polyurethane comprising foam may be submitted to a post-curing step. Post-curing may vary between wide ranges like between minutes and months and at a temperature between room temperature and 100° C. or higher.

According to embodiments, the polyurethane comprising material obtained after the first processing may be submitted to a post curing step. Post-curing may vary between wide ranges like between minutes and months and at a temperature between room temperature and 100° C. or higher.

According to embodiments, the polyurethane comprising material obtained after the first processing may be submitted to a gas infusion step. This step is performed prior to the second processing step (final expansion) and can be done at pressure P_{infusion}, where P_{infusion} can be higher and/or lower than P1 and a temperature T_{infusion}, where preferably T_{infusion}<Tₘₑₗₜ, more preferable T_{infusion}<T_{softening}. The time between this optional step and the second processing may vary between instantaneous up to 1 month or even longer.

According to embodiments, the intermediate polyurethane comprising material can be optionally subjected to a temperature sufficient to heat activate the blowing agent and insufficient to the softening of the polymer (T_{activate}<T<T_{softening}). This is performed prior to the second processing step (final expansion) and can be done at any desired pressure (in a standard oven, in a heated mould and/or an autoclave). It is possible to first bring the material back to a lower temperature (e.g. room temperature) prior to the second processing step. The time between this optional step and the second processing may vary between instantaneously up to 2 weeks or even longer. This optional step can be used to reduce the time needed in the autoclave/pressure vessel to activate the blowing agent.

According to embodiments, temperature used in the second processing (T₁), step d, is below the melting temperature Tₘₑₗₜ of the polyurethane comprising material: T₁<Tₘₑₗₜ. This method allows the material to retain its original shape (to a certain extend) during the expansion step, thereby reducing the need to use a mould in the second processing step.

According to embodiments, temperature used in the second processing (T₁), step d, is above the melting temperature Tₘₑₗₜ of the polyurethane comprising material: T₁>Tₘₑₗₜ. This method allows the material to be re-shaped (to a certain extend) during the expansion step, for example by using a mould in the second processing step.

According to embodiments, subjecting the polyurethane comprising material to a temperature sufficient to soften the polymer material (Tsoftening) wherein Tsoftening≥Tactivate in combination with an elevated pressure P1 wherein P1 is higher than atmospheric pressure (Patm) is performed for a time sufficient to activate at least 20% of the heat activatable blowing agent(s), more preferably a time sufficient to activate at least 50% of the heat activatable blowing agent(s), more preferably time sufficient to activate at least 75% of the heat activatable blowing agent(s), most preferably a time sufficient to activate at least 90% of the heat activatable blowing agent(s). Selecting the optimal time in step (d) for the 2^{nd} processing will result in evenly distributed cells and homogeneous cell size.

According to embodiments, subjecting the polyurethane comprising material to a temperature sufficient to soften the polymer material (Tsoftening) wherein Tsoftening≥Tactivate in combination with an elevated pressure P1 wherein P1 is higher than atmospheric pressure (Patm) is performed for a time of at least 1 minute, preferably between 2 minutes and 180 minutes, more preferably between 5 minutes and 15 minutes. Selecting the optimal time in step (d) for the 2^{nd} processing will result in evenly distributed cells and homogeneous cell size.

According to embodiments the intermediate polyurethane comprising material is non-foamed. The advantage of having a non-foamed intermediate polymer is to ensure a more homogeneous cell size in the polymer foam obtained in the 2^{nd} processing step with improved skin quality.

According to embodiments the intermediate polyurethane comprising material is created and/or processed in such way to create small holes or punctures before the 2^{nd} processing step. This improves the 2^{nd} processing step by shortening the time needed to saturate the sample and to obtain a better and more evenly expanded product. The polyurethane comprising material obtained after the first processing may be needle-punched via at least one surface. Preferably a perforation depth in the range of 60 to 100 percent of the material thickness is used. Preferably the needle-punching density is at least 50 punches per square meter. More preferably the needle-punching density is at least 500 punches per square meter. Most preferably the needle-punching density is at least 1000 punches per square meter.

According to embodiments, the polyurethane comprising foam material obtained after the second processing may be needle-punched via at least one surface to avoid shrinkage and/or skin defects. Preferably a perforation depth in the range of 60 to 100 percent of the material thickness is used. Preferably the needle-punching density is at least 50 punches per square meter. More preferably the needle-punching density is at least 500 punches per square meter. Most preferably the needle-punching density is at least 1000 punches per square meter.

### Examples

Chemicals Used:

| Polymeg ® | Polytetramethylene ether glycol (PTMEG) produced by |
|---|---|
| 2000 | polymerizing tetrahydrofuran from LyondellBasell, having |
| | an OH number of 56 mg KOH/g |
| BDO | Chain extender, 1,4-butanediol |
| Unifoam AZ | Blowing agent, Azodicarbonamide |
| MFE 600 | |
| TELA 99% | Crosslinker, Triethanolamine |
| Isocyanate 1 | 4,4′-MDI available as Suprasec ® MPR from Huntsman |
| Isocyanate 2 | Uretonimine modified 4,4′-MDI available as Suprasec ® |
| | 2020 from Huntsman |
| Isocyanate 3 | Polymeric MDI available as Suprasec ® 5025 from |
| | Huntsman |
| Isocyanate 4 | Isocyanate prepolymer based on Isocyanate 1 with |
| | Polymeg ® 2000 and an NCO content of 20% |
| Isocyanate 5 | Isocyanate prepolymer based on Isocyanate 2 with |
| | Polymeg ® 2000 and an NCO content of 20% |
| Isocyanate 6 | Isocyanate prepolymer based on Isocyanate 1 and |
| | Isocyanate 3 with Polymeg ® 2000 and an NCO content of |
| | 20% |

Preparation of the Isocyanate-Terminated Prepolymers:

Isocyanate 4 is prepared by loading 64.081 w % isocyanate 1 to a reactor at 60° C., adding 0.001 w % thionylchloride and stirring the mixture. The reactor contains a rotating mixing blade, thermometer and is continuously flushed by nitrogen using an in- and out-let. Then 35.918w % of Polymeg® 2000 at 60° C. is added in 30 minutes while stirring. After the addition of all components (100 w %) the mixture was heated to a temperature of 80° C. for 2 hours while continuously stirring. The reaction mixture was then cooled to room temperature and the NCO value of 20% was determined the next day.

Isocyanate 5 is prepared by loading 71.803 w % isocyanate 2 to a reactor at 60° C., adding 0.001 w % thionylchloride and stirring the mixture. The reactor contains a rotating mixing blade, thermometer and is continuously flushed by nitrogen using an in- and out-let. Then 28.196w % of Polymeg® 2000 at 60° C. is added in 30 minutes while stirring. After the addition of all components (100 w %) the mixture was heated to a temperature of 80° C. for 2 hours while continuously stirring. The reaction mixture was then cooled to room temperature and the NCO value of 20% was determined the next day.

Isocyanate 6 is prepared by loading 50.891 w % isocyanate 1 and 14.158 w % isocyanate 3 to a reactor at 60° C., adding 0.001 w % thionylchloride and stirring the mixture. The reactor contains a rotating mixing blade, thermometer and is continuously flushed by nitrogen using an in- and out-let. Then 34.950w % of Polymeg® 2000 at 60° C. is added in 30 minutes while stirring. After the addition of all components (100 w %) the mixture was heated to a temperature of 80° C. for 2 hours while continuously stirring. The reaction mixture was then cooled to room temperature and the NCO value of 20% was determined the next day.

Test Methods

All examples were tested/prepared using the methods described below:

The samples are made on the theoretical isocyanate index of 100. The pot life was monitored as the time where the mixture starts to gel.

### Examples Described in Table 1

The formulation of the examples is made in 3 separate blends, called the “isocyanate blend”, the “isocyanate reactive blend” and the “chain extender blend”. The isocyanate reactive blend (as shown in the examples) refers to other ingredients besides the isocyanate and chain extender and will contains polyols, crosslinkers, blowing agents and fillers. Catalysts and surfactants can be added to the “isocyanate reactive blend” or can be added as a separate stream.

The non-foamed or partly foamed polyurethane samples are made using a Cas.Tech DB9 cast elastomer machine. The “isocyanate blend” is kept at 40±1° C. and the “chain extender blend” and “isocyanate reactive blend” were kept at 45±1° C. respectively by the machine before the casting was done. When producing a non-foamed polyurethane polymer, all components are degassed prior to the casting of the systems. Samples are cast in a stand-up sheet mold set at a temperature of 80° C. to prepare A4 size samples with a thickness of 4 mm. The samples were demolded after curing (see demould time, table 1) to obtain the polyurethane comprising material which is solid at room temperature. A small cutout sample of 50×15×4 mm was made to be used for the 2nd processing step in the Buchi reactor autoclave. The Buchi reactor is a jacketed metal reactor vessel with a capacity of 2 liter with a certified temperature range from −20° C. up to 250° C. The reactor is tested and certified up to pressures of 60 bar at temperatures up to 250° C. The autoclave is heated to the temperature listed in table 1 (Autoclave temperature) at a heating rate of 1° C./min. The polyurethane comprising material is loaded in the autoclave when it has reached the autoclave temperature, by hanging the sample on a metal hook in the center of the autoclave. The pressure in the autoclave is immediately (right after loading the sample) increased to 25 or 50 bar at a rate of 7.5 Bar/sec by using a nitrogen tank (each sample shown in table 1 is processed at both pressures, resulting in a different final foam density). At the autoclave temperature the settings are maintained for the runtime (shown in Table 1) to activate the heat activatable blowing agent. The pressure is then reduced to atmospheric pressure (Pₐₜₘ) at a speed of >10 bar/sec by opening a valve to allow the material to expand. The sample is unloaded by opening the autoclave after the expansion step (while the reactor is still at the autoclave temperature). The density of the samples (foamed sample including its skin) is measured by ISO 1183-1 and expressed in kg/m³.

Examples 3, 4 and 5 described in table 1 are according to the invention while example 1 and 2 are comparative examples. Comparative example 1 is lacking both a crosslinker and a heat activatable blowing agent. Comparative example 2 is lacking a crosslinker. The experimental data shown in table 1 clearly shows the significantly lower density of the final foams from example 3, 4 and 5 according to the invention.

The foam samples made according to the invention have all been made below the melting temperature of the polyurethane comprising material, both for the first processing (polymerization) and the second processing (expansion). Furthermore the pressures required in the second processing (expansion) of the samples according to the invention are relatively low compared to methods where supercritical gas infusion is used. This has clear benefits in the simplification of the overall process and reduction in energy consumption to prepare polyurethane foams.

TABLE 1
Examples to demonstrate the effect of composition

| | | Formulation (Parts by weight) | | | | |
|---|---|---|---|---|---|---|
| Material | | 1 | 2 | 3 | 4 | 5 |
| Polymeg 2000 | | 46.59 | 46.59 | 52.01 | 45.8 | 45.25 |
| BDO | | 7.53 | 7.67 | 6.01 | 7.37 | 6 |
| Dabco 25s | | 0.2 | 0.05 | | | |
| Unifoam AZ MFE 600 | | | 3 | 3 | 3 | 3 |
| TELA 99% | | | | | | 1.62 |
| Isocyanate 4 | | 45.68 | 45.69 | | | 44.13 |
| Isocyanate 5 | | | | 38.98 | | |
| Isocyanate 6 | | | | | 43.84 | |
| Sum pbw system | | 100 | 103 | 100 | 100 | 100 |
| Isocyanate index | | 100 | 100 | 100 | 100 | 100 |
| Hard block level | % | 37 | 37 | 37 | 37 | 37 |
| Functionality reactive | | 2 | 2 | >2 | >2 | >2 |
| mixture | | | | | | |
| Pot life | s | 77 | 49 | 75 | 70 | 55 |
| Used demould time | min | 27 | 10 | 35 | 35 | 35 |
| Autoclave Runtime | min | 15 | 5 | 15 | 15 | 5 |
| Autoclave temperature | ° C. | 180 | 180 | 180 | 180 | 190 |
| Pressure reduction speed | Bar/sec | >10 | >10 | >10 | >10 | >10 |
| Density (P₁ = 50 bar N₂) | kg/m³ | 945 | 745 | 180 | 180 | 180 |
| Density (P₁ = 25 bar N₂) | kg/m³ | 970 | 745 | 210 | 230 | 360 |

The recyclability of the foam from example 3 was also tested and it was very well recyclable via compression moulding using a Fontijne Lab-press TP400 at a temperature of 180° C. for 3×3 minutes using a pressure of 50 kN.

The examples A-H in Table 2 are all according to the invention and show how robust the processing is to obtain a low density foam. The chemical composition of these samples is all identical and can be found as formulation 3 in Table 1. Some samples (D, E, F and G) have been submitted to a post-treatment of the intermediate polyurethane material after the first processing (polymerization) and before the 2^{nd} processing (expansion). Samples E and G have been additionally conditioned after the post-treatment and before the 2^{nd} processing (expansion). Sample B has been expanded using a low pressure reduction speed (<1 bar/sec). Sample C was post-cured after the 2^{nd} processing (expansion). Sample H was made by using dry air as the gas to pressurize the autoclave.

TABLE 2
Examples to demonstrate the effect of Processing conditions

| Processing conditions | | | A | B | C | D | E | F | G | H |
|---|---|---|---|---|---|---|---|---|---|---|
| Chemical composition | | | Formulation 3 as shown in Table 1 (identical | | | | | | | |
| | | | processing to obtain the intermediate polyurethane | | | | | | | |
| | | | comprising material) | | | | | | | |
| Post-treatment | | Minutes | NA | NA | NA | 15 | 15 | 90 | 90 | NA |
| intermediate polyurethane | | ° C. | | | | 150 | 150 | RT | RT | |
| comprising material | | Bar | | | | Pₐₜₘ | Pₐₜₘ | 50 | 50 | |
| Conditioning material | | days | NA | NA | NA | NA | 14 | NA | 14 | NA |
| after post-treatment | | ° C. | | | | | RT | | RT | |
| | | Bar | | | | | Pₐₜₘ | | Pₐₜₘ | |
| Autoclave | Runtime | Minutes | 15 | 15 | 15 | 15 | 15 | 15 | 15 | 15 |
| settings | Temperature | ° C. | 180 | 180 | 180 | 180 | 180 | 180 | 180 | 180 |
| (expansion | Pressure | Bar | 50 | 50 | 50 | 50 | 50 | 50 | 50 | 50 |
| step) | Gas used | | N₂ | N₂ | N₂ | N₂ | N₂ | N₂ | N₂ | Dry |
| | | | | | | | | | | air |
| | Pressure | Bar/sec | >10 | <1 | >10 | >10 | >10 | >10 | >10 | >10 |
| | reduction | | | | | | | | | |
| | speed | | | | | | | | | |

| Post curing after | Minutes | NA | NA | 960 | NA | NA | NA | NA | NA |
|---|---|---|---|---|---|---|---|---|---|
| expansion | ° C. | | | 80 | | | | | |
| | Bar | | | Pₐₜₘ | | | | | |
| Density | kg/m³ | 180 | 180 | 180 | 200 | 205 | 250 | 260 | 180 |

NA: Not Applicable
Pₐₜₘ: Atmospheric pressure
RT: Room temperature (~21° C.)

1. A 2-step processing method to form a partly cross-linked polyurethane (PU) comprising foam having a density below 600 kg/m³, said method comprising:
A first processing which comprises at least the following steps:
a) providing a reactive mixture comprising an isocyanate composition comprising at least one isocyanate compound, an isocyanate-reactive composition comprising at least one isocyanate reactive compound, a crosslinking agent and a blowing agent composition comprising at least a heat activatable blowing agent which is heat activatable to achieve blowing at an activation temperature T_{activate}, and
b) allowing the reactive mixture to polymerize, optionally using a shape or mold, at a process temperature T_{process} wherein T_{process}<T_{activate} and T_{process}<Tₘₑₗₜ to form a polyurethane comprising material having a melting temperature Tₘₑₗₜ and which is solid at room temperature, and then
A second processing which comprises at least the following steps:
c) placing the polyurethane comprising material in an autoclave, pressure vessel or pressurizable mold,
d) subjecting the polyurethane comprising material to a temperature sufficient to soften the polymer material (T_{softening}) wherein T_{softening}≥T_{activate} in combination with an elevated pressure P₁ wherein P₁ is higher than atmospheric pressure (Pₐₜₘ), and then
e) subjecting the polyurethane comprising material to a pressure reduction which is sufficient to achieve expansion (foaming) and to obtain the partly cross-linked polyurethane comprising foam.

2. The method according to claim 1 wherein the partly cross-linked polyurethane comprising foam is a thermally recyclable polyurethane comprising foam.

3. The method according to claim 1, wherein the reactive mixture has an overall nominal average functionality in the range 2-2.3.

4. The method according to claim 1, wherein the reactive mixture has a nominal average iso-reactive functionality in the range 1.5-4 and/or a nominal average isocyanate functionality in the range 1.5-4.

5. The method according to claim 1, wherein the crosslinking agent in the reactive mixture is selected from isocyanate reactive compounds having a nominal average iso-reactive functionality higher than 2.

6. The method according to claim 1, wherein the crosslinking agent in the reactive mixture is selected from compounds which are reactive at temperatures below the or equal to the melting temperature Tₘₑₗₜ.

7. The method according to claim 1, wherein the polyurethane comprising material obtained in the first processing is submitted to a post-curing step before the second processing.

8. The method according to claim 1, wherein the isocyanate index of the reactive mixture is between 80 and 120.

9. The method according to claim 1, wherein the heat activatable blowing agent is selected from a chemical blowing agent having an activation temperature above 80° C.

10. The method according to claim 1, wherein the heat activatable blowing agent is selected from azodicarbonam ides, azobisisobutyronitrile, azodicarbonic methyl ester, diazabicyclooctane, dinitrosopentamethylenetetramine, toluenesulfonyl hydrazide, benzene sulfonyl hydrazide, trihydrazinotriazine and/or diaminodiphenylsulphone and mixtures thereof.

11. The method according to claim 1, wherein the heat activatable blowing agent is selected from a physical blowing agent selected from encapsulated physical blowing agents and expandable microspheres where a gas or gas forming compound is encapsulated in a polymer shell having an activation temperature T_{activate}>T_{process} and/or non-encapsulated physical blowing agents selected from chlorofluorocarbons, halogenated hydrocarbons and/or non-halogenated hydrocarbons which have an activation temperature T_{activate}>T_{process}.

12. The method according to claim 1, wherein the blowing agent composition comprises at least 50 wt % of heat activatable blowing agents which are heat activatable at an activation temperature T_{activate}, which is higher than the processing (polymerization) temperature T_{process} (T_{process}<T_{activate}) based on the total weight of the blowing agent composition.

13. The method according to claim 1, wherein the reactive mixture comprises less than 0.5 wt % water calculated on the total weight of the reactive mixture.

14. The method according to claim 1, wherein the first processing is performed in a first mold and the second processing is performed in a second mold and wherein the first mold is different to the second mold and the second mold corresponds to the final desired shape of the polyurethane comprising foam.

15. The method according to claim 1, wherein the step of subjecting the polyurethane comprising material to an elevated pressure P₁ (step d)) wherein P₁ is higher than atmospheric pressure (Pₐₜₘ) is performed in a pressure range Pₐₜₘ<P₁<250 bar.

16. (canceled)

17. The method according to claim 1, wherein the temperature in the second processing within the pressure vessel is preferably kept in the range 30-250° C.

18. The method according to claim 1, wherein the second processing which comprises placing the polyurethane comprising material in a pressure vessel or pressurized mold (step b)) is performed in an autoclave in an inert atmosphere.

19. The method according to claim 1, wherein the temperature used in the second processing (T₁) step d) is below the melting temperature Tₘₑₗₜ of the polyurethane comprising material (T₁<Tₘₑₗₜ).

20. A partly cross-linked polyurethane (PU) comprising foam obtained after to the second processing of the 2-step processing method according to claim 1, wherein said foam has a density in the range 100-300 kg/m³.
